(19) United States
(12) Patent Application Publication
(10) Pub. No.: US 2005/0232551 A1
(43) Pub. Date: Oct. 20, 2005

(54) Devices for preventing lens contamination in optoelectronic modules and connectors

(76) Inventors: Cheng-Pei Chang, Perak (MY); Chiew Loon Siew, Perak (MY); Voon Hon Liew, Perak (MY)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/091,632

(22) Filed: Mar. 28, 2005

Related U.S. Application Data
(60) Provisional application No. 60/562,721, filed on Apr. 16, 2004.

(51) Int. Cl. G02B 6/36

(52) U.S. Cl. 385/76; 385/53

(57) ABSTRACT

Embodiments of the present invention provide devices designed to protect the functional components of optoelectronic devices and connectors from damage. Some embodiments of the present invention provide removable plugs for various types of optoelectronic modules. Each of these plugs can include a base having two spaced apart insertion members extending from the base. Each of said insertion members can include a recess insertable within a port of the module and a coplanar first surface with at least one stepped portion extending from the coplanar first surface. The stepped portions can be sized and configured to snugly fit within corresponding structures in the modules, thus preventing debris contamination. Additional embodiments of the present invention provide end caps that protect various types of fiber optic connectors.

### CROSS REFERENCE TO RELATED APPLICATIONS

This application claims priority to U.S. Provisional Patent Application No. 60/562,721, filed on Apr. 16, 2004, and entitled “Fiber Connector Devices for Preventing Lens Contamination”, which is incorporated herein by reference in its entirety.

### BACKGROUND OF THE INVENTION

1. The Field of the Invention

Embodiments of the present invention relate to the field of fiber optic connectors and transceivers and, more specifically, to devices designed to protect the functional components of these connectors and transceivers from damage.

2. The Relevant Technology

Fiber optic communications systems have existed for some time. In an effort to achieve interoperability between fiber optic system components made by different manufacturers, various standards have been set. For example, there are standards that govern the physical size of particular modules, connectors, and other components.

One problem associated with these standardized components is keeping the various surfaces clean and free from dirt, dust, and other debris. When such foreign matter contacts the lenses or fiber endfaces associated with these components, it can cause a loss of signal quality. In extreme cases, such debris can degrade a signal to the point that no data can be passed.

Various caps and/or plugs have been designed to alleviate the above mentioned problems for specific types of components, such as, for example, optoelectronic transceiver modules and fiber optic connectors. The module types are based on various standard form factors. One example of these form factors is a Small Form X (SFX) module. A typical plug used to protect an SFX module is shown in FIGS. 1A-1C, and designated generally as reference numeral 100. The SFX module typically includes ports for a transmitter optical sub-assembly and a receiver optical sub-assembly. The plug is designed to fit snugly in each of these ports to prevent dust and other material from contaminating the surfaces of the lenses used to focus or collimate the light signals transmitted to and from the module.

As can be seen in FIGS. 1A-1C, plug 100 includes a first insertion member 102 and a spaced apart second insertion member 104. Each first insertion member 102 and second insertion member 104 extends from a base member 106. Insertion members 102, 104 are designed to fit snugly within the ports of an SFX transceiver module (not shown). To aid with the mounting of members 102 and 104 to the ports of the SFX transceiver module, each member 102 and 104 includes a recess 108 and 110, respectively. Disposed at a bottom of recess 108 is a protrusion 112, while a similar protrusion 114 is disposed at the bottom of recess 110.

Unfortunately, plug 100 suffers from some drawbacks. First, insertion members 102, 104 are difficult to insert and can become jammed within the SFX transceiver module. During insertion or forced removal, a portion of insertion members 102, 104 can be scraped off, thus contaminating the very area plug 100 was designed to protect. Alternately, members 102, 104 can fail to completely seal the opening in the port, thus allowing foreign matter to contaminate the interior surfaces. Additionally, protrusions 112 and 114 can physically contact the lenses of the laser and/or photodiode of the SFX transceiver module. Any debris on protrusion 112 and 114 can transfer to the lens and reduce the effectiveness of the SFX transceiver module.

Another example of a plug is shown in FIGS. 2A-2C, and designated generally as reference numeral 150. Plug 150 is designed to be used with a Gigabit Interface Converter (GBIC) module. Plug 150 includes a first insertion member 152 and a spaced apart second insertion member 154. Insertion members 152, 154 are designed to fit snugly within the ports of the GBIC transceiver module (not shown). As illustrated, members 152, 154 extend from an intermediate portion 156, while a protuberance 158 extends from intermediate portion 156. An individual can use protuberance 158 to insert and remove plug 150 from the ports of the GBIC transceiver module.

To aid with mounting to the ports of a GBIC module, member 152 includes a recess 160 that can receive a laser diode or a photodiode. As with plug 100 illustrated in FIGS. 1A-1C, member 152 also includes a protrusion 162 extending from a bottom of recess 160. Additionally, member 152 includes a portion 164 formed thereabout that has a bottom spaced apart from an uppermost portion of protrusion 158. Likewise, member 154 includes a recess 166 within which can receive a laser diode or a photodiode. Member 154 also includes a protrusion 168 extending from a bottom of recess 166. Additionally, member 154 includes a portion 170 formed thereabout that has a bottom spaced apart from an uppermost portion of protrusion 168.

Unfortunately, plug 150 also suffers from some drawbacks. As with plug 100, insertion members 152, 154 are difficult to insert and can become jammed within the module. Forced removal can then allow a portion of insertion members 152, 154 to be scraped off, thus contaminating the very area the plugs were designed to protect. Alternately, members 152, 154 can fail to completely seal the opening in the port, thus allowing foreign matter to contaminate the interior surfaces. Additionally, protrusions 162, 168 can physically contact the lenses of the module. Any debris on the protrusions can thus be transferred to the lens. Plugs 100, 150 often fail to provide a complete seal around the inside surfaces of a module, thus allowing foreign matter to accumulate.

### BRIEF SUMMARY OF THE EMBODIMENTS

Embodiments of the present invention relate to the field of fiber optic connectors and transceivers and, more specifically, to devices designed to protect the functional components of these connectors and transceivers from damage. Some embodiments of the present invention provide plugs for various types of optoelectronic modules that overcome the problems associated with the plugs discussed above. Additional embodiments of the present invention provide end caps that protect various types of fiber optic connectors. For the purposes of this application, the term “exemplary” is strictly used to mean “an example of”.

Exemplary embodiments provide a first and a second spaced apart insertion member that can be connected to a base. Each of the insertion members can have a recess therein and can be sized and configured to fit within a port of the module. A coplanar first surface, having at least one step therein, can be formed on each insertion member. The steps can be sized and configured to snugly fit within corresponding structures in the modules, thus preventing debris contamination. While specific embodiments are shown for use with SFX and GBIC modules, the specific design of the exemplary embodiments can be used with plugs for other optoelectronic modules as well, including but not limited to, XFP, SFP, and other types of modules known to those of skill in the art.

In an alternate embodiment of the present invention, an end cap for an optical connector is provided. The end cap can include first and second spaced apart side walls. The end cap can also have at least one recess in one of a third and fourth side wall. This at least one recess can be located such that it engages with a corresponding tab on the optical connector when the end cap is placed on the optical connector. The end cap can also include an annular member located in an interior portion of the end cap. This annular member can be designed to receive a portion of a fiber optic cable that extends from an end of the optical connector. This allows the end face of the optical connector to be secured within the end cap without touching the end cap. This feature helps prevent unwanted contamination of the fiber optic cable when the end cap is installed or removed.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIGS. 1A-1C illustrate various views of a prior art version of an SFX plug;

FIGS. 2A-2C illustrate various views of a prior art version of a GBIC plug;

FIG. 3A illustrates a perspective view of one embodiment of an SFX plug according to one aspect of the present invention;

FIG. 3B illustrates a cross-sectional side view of the connector plug of FIG. 3A;

FIG. 3C illustrates a front view of the connector plug of FIG. 3A;

FIG. 3D illustrates a perspective view of the connector plug of FIG. 3A fully inserted into an SFX module;

FIG. 3E illustrates a perspective view of the connector plug of FIG. 3A partially inserted into an SFX module;

FIG. 4A illustrates a perspective view of one embodiment of a GBIC plug according to one aspect of the present invention;

FIG. 4B illustrates a perspective view of the connector plug of FIG. 4A;

FIG. 4C illustrates a cross-sectional side view of the connector plug of FIG. 4A;

FIG. 4D illustrates a perspective view of the connector plug of FIG. 4A fully inserted into a GBIC module;

FIG. 4E illustrates a perspective view of the connector plug of FIG. 4A partially inserted into a GBIC module;

FIG. 5A illustrates a perspective view of one embodiment of an SC connector endcap according to yet another alternate aspect of the present invention;

FIG. 5B illustrates a cross-sectional side view of a portion of the SC connector endcap of FIG. 5A;

FIG. 5C illustrates a bottom view of the connector endcap of FIG. 5A;

FIG. 5D illustrates a side view of the SC connector endcap of FIG. 5A;

FIG. 5E illustrates a perspective view of the connector endcap of FIG. 5A fully inserted onto an SC connector; and

FIG. 5F illustrates a perspective view of the connector endcap of FIG. 5A aligned with an SC connector.

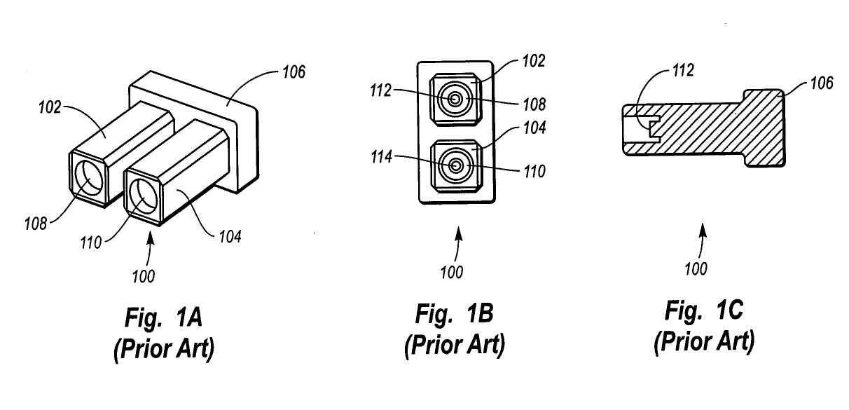

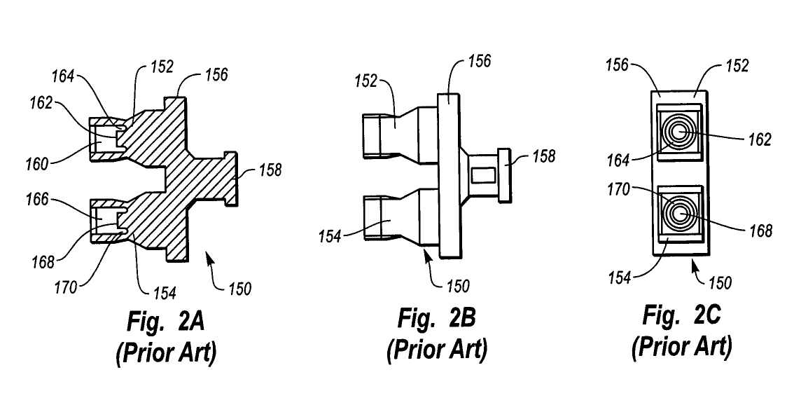

### DETAILED DESCRIPTION OF THE EMBODIMENTS

Embodiments of the present invention provide plugs for various types of optoelectronic modules that overcome the problems associated with the plugs discussed above. Specific embodiments of a plug for an SFX module and a GBIC module are illustrated. However, the specific design of the exemplary embodiments can be used with plugs designed for other modules, including, but not limited to, SFF, SFP, XFP and other modules. Additional embodiments of the present invention provide end caps that can be used to protect various types of fiber optic connectors.

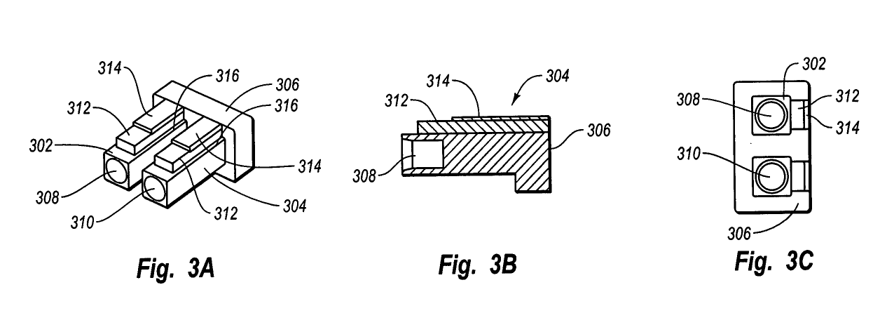

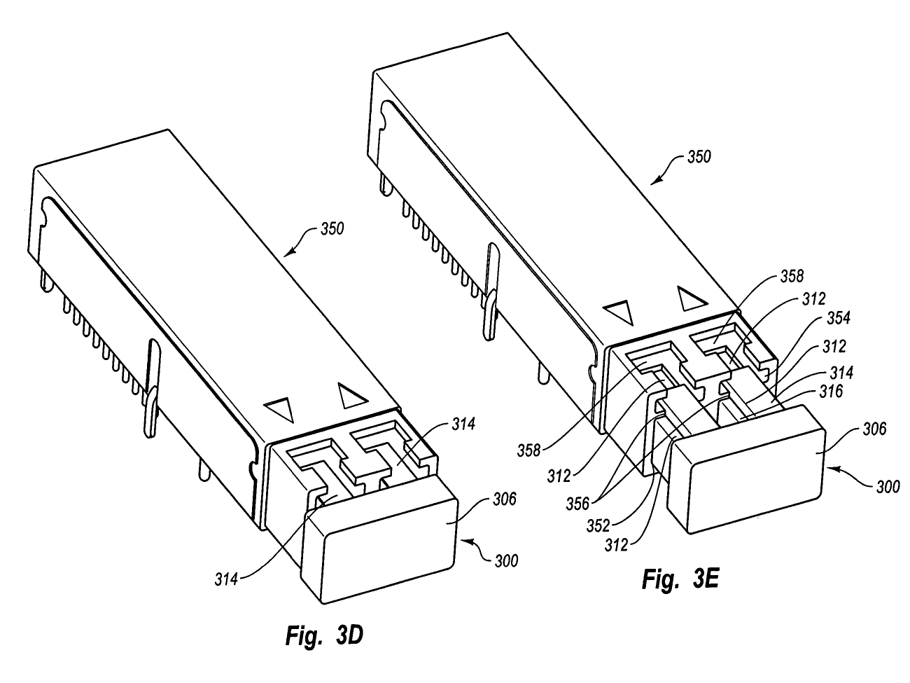

FIGS. 3A-3E illustrate one embodiment of an SFX plug, designated generally as reference numeral 300, according to one aspect of the present invention. Plug 300 can include a pair of spaced apart insertion members 302, 304 attached to a base 306. The spacing of insertion members 302, 304 can be selected to enable each insertion member 302, 304 to engage with a port 352, 354 of a corresponding SFX transceiver module 350 (FIGS. 3D and 3E). It will be understood that the spacing of members 302, 304 can be selected so that plug 300 can engage with or be disposed within at least a portion of a port of another type of transceiver module.

The illustrated insertion members 302, 304 have generally the same cross-sectional outer dimension along their length. The outer dimensions of insertion members 302, 304 have been designed and selected to provide a better fit with the SFX transceiver module 350 and to avoid abrasion resistance. Optionally, the corners of each insertion member 302, 304 can be chamfered, curved, or have some other configuration to enable easy insertion into a portion of SFX transceiver module 350. Generally, insertion members 302, 304 can have various cross-sectional configurations, such as, but not limited to, square, rectangular, oval, polygonal, combinations thereof, or the like.

In other configurations, however, each insertion member 302, 304 may have a tapered configuration, where the cross-sectional outer dimension reduces along its length from base 306 toward an end of each insertion member 302, 304. Additionally, the cross-sectional dimension of insertion members 302, 304 can be reduced to be smaller than the ports 352, 354 of SFX transceiver module 350 to allow for easier insertion.

To further aid with the mounting of members 302 and 304 to ports 352, 354 of SFX transceiver module 350, and more generally of any type of transceiver module, each member 302 and 304 can include a recess 308 and 310. Recesses 308 and 310 help prevent protruding portions (not shown) of SFX transceiver module 350 from contacting the plug, which helps to prevent surface contamination of the optical elements within SFX transceiver module 350, since no contact is made between the plug and these elements. In contrast to existing plugs, no protrusion is disposed at a bottom of each recess 308, 310. Further, the ends of recesses 308 and 310 or the edges of recesses 308 and 310 have a radius profile (as shown in FIG. 3B) to limit the possibility of material being introduced into the interior of recesses 308 and 310 following multiple insertions into SFX module 350. In some embodiments, the ends of recesses 308, 310 can have a chamfered profile

One or more steps 312, 314 can be included on at least one outside surface of insertion members 302, 304, respectively. These steps 312, 314 aid the user with inserting plug 300 into engagement with SFX transceiver module 350. The step 312 defines a lip 316 on the insertion members 302, 304. The width of step 312 can be chosen to allow tabs 356 within ports 352, 354 to fit snugly against the side of step 312, and on top of lip 316. Further, the steps 312, 314 aid in locking plug 300 to SFX transceiver module 350. As shown, one step 314 can be generally aligned with a surface of base 306, while step 312 can be disposed intermediately between this surface of base 306 and the outer surface of one or both of insertion members 302, 304. It will be understood that various numbers of steps may be used, such as but not limited to one or more steps. For instance, a single step can transition between the surface of base 306 and the outer surface of one or both of insertion members 302, 304.

In the embodiment illustrated in FIGS. 3D and 3E, step 312 fits within ports 352, 354 when plug 300 is fully inserted into module 350. Step 314 can then fit snugly against a rear portion 358 of ports 352, 354. This configuration helps prevent dust or other contaminants from entering ports 352, 354. In addition to the above, it will be understood that other configurations of the present invention can utilize a tapered portion that extends between base 306 and the outer surface of insertion members 302, 304.

In exemplary embodiments, plug 300 can be made from various types of materials. These materials can be selected to have properties desirable in a module plug. For example, these materials can be antistatic. They can be tested and certified to pass various flammability standards, such as, but not limited to, the Underwriters Laboratory (UL) UL94, V0 test. They can be certified to pass one or more of the outgassing standards of the American Society for Testing and Materials (ASTM), such as ASTM E595. The plugs 300 can also be tested for reliability with respect to vibration, shock, temperature cycling, etc. Such materials can be, by way of example and not limitation, polyurethane, ethylene-propylene diolefin monomer (EPDM), or other plastics or polymers known to those of skill in the art that have the desired properties.

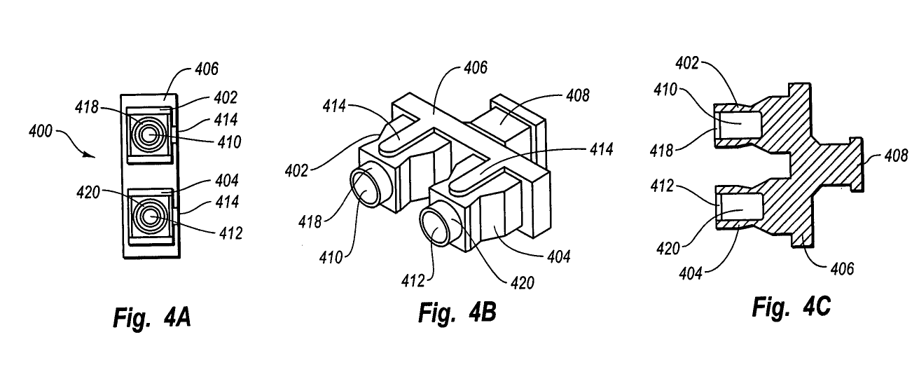

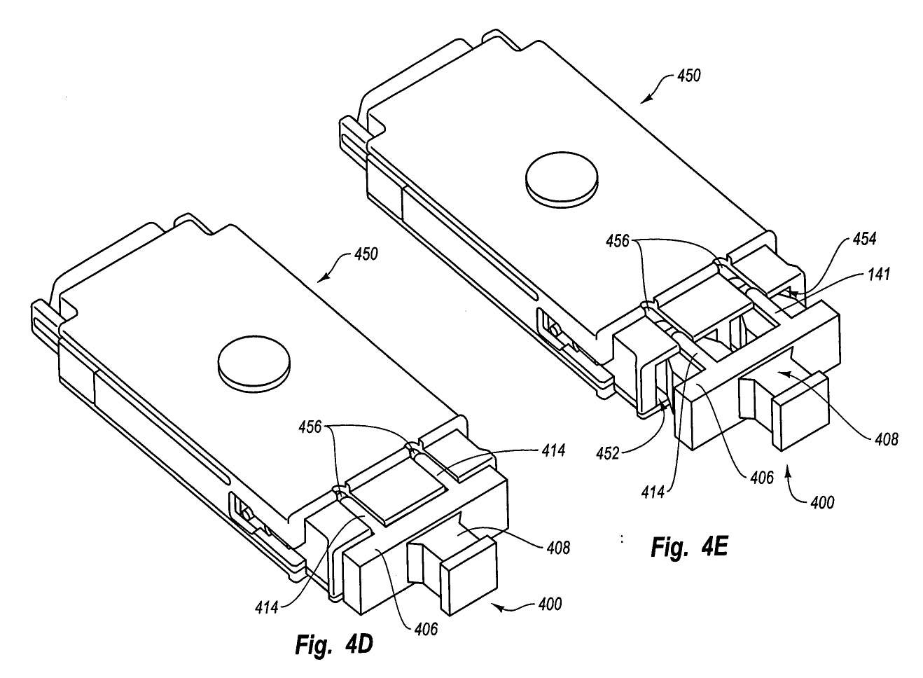

FIGS. 4A to 4E illustrate various views of one exemplary embodiment of a GBIC plug, designated generally as reference numeral 400, according to an alternate configuration of the present invention. Plug 400 includes a pair of spaced apart insertion members 402, 404 attached to one side of a base 406. The spacing of insertion members 402, 404 is selected to enable each insertion member 402, 404 to engage with a port 452, 454 of a corresponding GBIC transceiver module 450 (FIGS. 4D and 4E). It will be understood that the spacing of members 402, 404 can be selected so that plug 400 can engage with or be disposed within at least a portion of a port of another type of transceiver module.

The illustrated insertion members 402, 404 can have a generally tapered portion, the cross-sectional outer dimension of which can vary along its length. In the illustrated embodiment, the cross-sectional outer dimension of each insertion member 402, 404 reduces along the length from base 406 toward an end of each insertion member 402, 404. The outer dimensions of insertion members 402, 404 near base 406 have been selected to provide a better fit with GBIC transceiver module 450 and to avoid abrasion resistance. Optionally, the corners of each insertion member 402, 404 can be chamfered, curved, or have some other configuration to enable easy insertion into a portion of GBIC transceiver module 450. Generally, insertion members 402, 404 can have various cross-sectional configurations, such as, but not limited to, square, rectangular, oval, polygonal, combinations thereof, or the like.

Although the illustrated configuration has a partially tapered configuration, other configurations of plug 400 can include insertion members 402, 404 with generally uniform cross-sectional outer dimensions along the lengths of insertion members 402, 404 from base 406 toward an end of each insertion member 402, 404. Additionally, the cross-sectional dimension of insertion members 402, 404 can be reduced to be smaller than ports 452, 454 of GBIC transceiver module 450 to allow for easier insertion into the GBIC transceiver module 450.

To aid in inserting and removing insertion members 402, 404 into and out of GBIC module 450, a handle portion 408 can extend from base 406 on a side opposite insertion members 402, 404. This handle portion 408 can have various configurations so long as it provides a structure that an individual may use to grasp plug 400 and to insert and remove plug 400 into/from GBIC transceiver module 450. As illustrated, handle portion 408 includes a raised end portion that may be grasped by an individual to manipulate plug 400. Although a single raised end portion is illustrated, one skilled in the art can appreciate that handle portion 408 can include one or more dents, protrusions, extensions, depressions, etc. that provide additional tactile feel and control to an individual manipulating plug 400 and that provide additional structures to increase the frictional contact between an individual and handle portion 408.

Each member 402 and 404 can include a recess 410 and 412. Recesses 410 and 412 help prevent protruding portions (not shown) of GBIC transceiver module 450 from contacting plug 400. In contrast to existing plugs, no protrusion is disposed at a (bottom of each recess 410, 412. This prevents contact between protruding portions of GBIC transceiver module 450 and the interior of plug 400. This helps to prevent surface contamination of the optical elements within GBIC transceiver module 450 since no contact is made between the plug and these elements. Further, the ends of recesses 410 and 412 or the edges of recesses 410 and 412 can have a radius or chamfered profile to limit the possibility of material being introduced into the interior of recesses 410 and 412 following multiple insertions into GBIC module 450.

To make plug 400 easier to insert, and to ensure a more effective seal, one or more steps or guides 414 can be included on at least one outside surface of insertion members 402, 404. These guides can be centered with respect to ports 452, 454 of module 450. As shown, step 414 can be generally aligned with a surface of base 406 and the outer surface of insertion members 402, 404. Each step 414 can include a rounded end to aid with engagement with a corresponding slot 456 in GBIC transceiver module 450. For instance, the rounded end aids with guiding placement of plug 400 into engagement with ports 452, 454 of GBIC transceiver module 450. Although rounded ends are illustrated, one skilled in the art will appreciate that various other end configurations are possible, including, but not limited to, generally planar ends, polygonal ends, curved ends, or the like.

It will be understood that in other configurations, one or more steps may be substituted for each step 414. For instance, one step can be generally aligned with a portion of base 406, while another step can be disposed intermediately between the surface of base 406 and the outer surface of one or both of insertion members 402, 404. It will be understood that various numbers of steps may be used, such as but not limited to one or more steps. For instance, a single step can transition between the surface of base 406 and the outer surface of one or both of insertion members 402, 404. Further, it will be understood that other configurations of the present invention can utilize a tapered portion that extends between base 406 and the outer surface of insertion members 402, 404.

In addition to recesses 410, 412, each insertion member 402, 404 can include a cylindrical protrusion 418, 420, respectively. These cylindrical protrusions 418, 420 can have lumens that form part of recesses 410, 412, respectively. The lumens of protrusions 418, 420 can be sized such that they encapsulate a portion of a cylinder (not shown) located inside the GBIC module, thus providing additional protection from dust and contaminants for lenses that are located within the cylinders. It will be understood that in other configurations, each insertion member 402, 404 may be devoid of protrusions 418, 420. In addition, each protrusion 418, 420 may have various other cross-sectional configurations, such as, but not limited to, square, rectangular, oval, polygonal, combinations thereof, or the like.

In the illustrated embodiments, plug 400 can be made from various types of materials. These materials can be selected to have properties desirable in a module plug. For example, these materials can be antistatic. They can be tested and certified to pass various flammability standards, such as, but not limited to, the Underwriters Laboratory (UL) UL94 test, or the V0 test. They can be certified to pass one or more of the outgassing standards of the American Society for Testing and Materials (ASTM), such as ASTM E595. The plugs 400 can also be tested for reliability with respect to vibration, shock, temperature cycling, etc. Such materials can be, by way of example and not limitation, polyurethane, ethylene-propylene diolefin monomer (EPDM), or other plastics or polymers known to those of skill in the art that have the desired properties.

While exemplary embodiments of the present invention are shown in FIGS. 3 and 4, the invention is not limited to these specific embodiments. Exemplary embodiments of the present invention can also be used with other types of electronic and optoelectronic modules. Such modules can include, by way of example and not limitation, XFP, SFP, and other types of modules known to those of skill in the art.

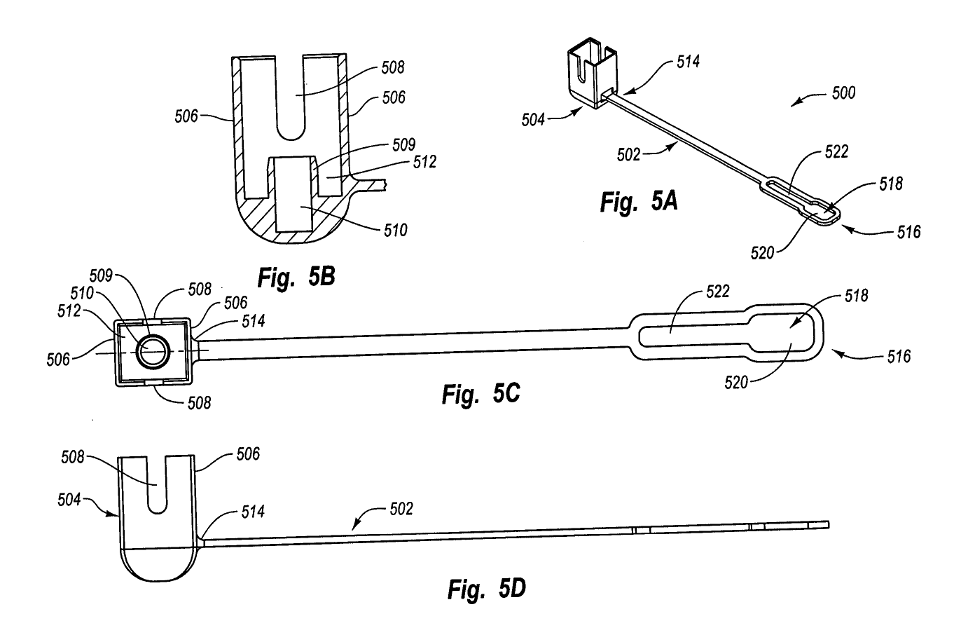

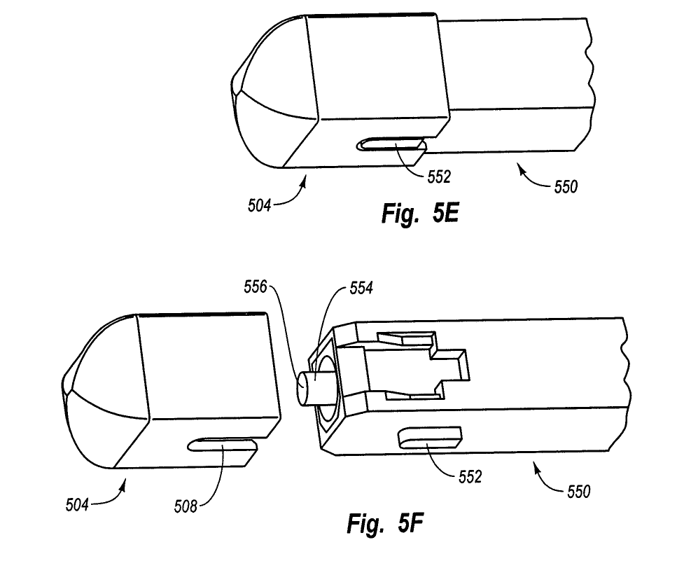

FIGS. 5A-5F illustrate one exemplary embodiment of an endcap 500 for a subscriber connector (SC) connector 550 (FIGS. 5E and 5F), according to yet another aspect of the present invention. The endcap 500 interference fits with the SC connector 550 to prevent debris entering onto the fiber ends of the SC connector 550. The interference fit is sufficient to maintain engagement between endcap 500 and the SC connector 550. The interference fit of the presently described endcap 500 eliminates the need for the existing abrasion-type rotationally mounted endcaps that damage the SC connector and remove material from either the endcap or the SC connector; this material potentially contaminating the SC connector and its fiber ends.

In the illustrated configuration, endcap 500 includes a handle portion 502 and a cap portion 504. The handle portion 502 enables an individual to mount end cap portion 504 to the SC connector 550. This allows the end cap 500 to remain with the connector 550 when the connector is in use, thus preventing it from getting lost or misplaced. The handle portion 502 can optionally be either permanently attached or removably attached to SC cap portion 504. The specific design of handle portion 502 is discussed in greater detail below.

As shown, cap portion 504 is designed to fit over the end of the SC connector 550, as shown in FIG. 5E. FIG. 5E only shows an end portion of the SC connector 550 that receives the cap 500 and does not show the entire connector. To aid in securing cap portion 504 to the end of SC connector 550, cap portion 504 can include a pair of side walls 506 that define a pair of recesses 508 on the opposing two sides. The recesses 508 are configured to engage, mate, or receive a complementary tab structure 552 formed on SC connector 550.

With reference to FIGS. 5B and 5C, the cap portion 504 can further include a raised annular portion 509 that defines a recessed portion 510 within cap portion 504. The raised annular portion 509 is sized and located to accept a portion of a fiber optic cable 554 that extends from SC connector 550. The recesses 508 and tabs 552 can cooperate to allow only a portion of fiber optic cable 554 to extend into recessed portion 510. Unlike the prior art versions, this design allows cap portion 504 to fit securely over the end of SC connector 550, without contaminating an end 556 of fiber optic cable 554. The end 556 of fiber optic cable 554 can be held securely in recessed portion 510, without contacting any other portion of end cap 504. In this embodiment, no part of end 556 comes in contact with any surface while cap portion 504 is installed and/or removed. This ensures that end 556 remains free from dust, dirt, and other contaminants that could be transferred to the surface of end 556 during contact. This embodiment provides some advantages over existing caps. Additionally, compared to what is presently available, cap portion 504 is bigger. This facilitates purging of cap portion 504 using, by way of example and not limitation, canned air, to remove dirt, dust and debris from the inside surfaces of cap portion 504.

In addition to assisting in the secure attachment of cap portion 504 onto SC connector 550, the engagement of recess 508 and tabs 552 aid to limit rotational movement of cap portion 504 relative to SC connector 550 and vice versa. Although recess 508 and tabs 552 function to position cap portion 504 onto SC connector 550 and to prevent rotational movement of cap portion 504 relative to SC connector 550, various other manners of performing such functions are possible. For instance, and not by way of limitation, mechanical fasteners, protrusions and locking recesses, or other manners or techniques known to one skilled in the art are possible.

As illustrated in FIGS. 5A and 5C, handle portion 502 has a proximal end 514 and a distal end 516. The proximal end 514 connects to cap portion 504. The distal end 516 can include a hole 518 that can receive an optical fiber to which SC connector 550 is attached. In this manner, handle portion 502 can be associated with one or more optical fibers and one particular SC connector 550. To aid with engaging SC connector 550 and its associated optical fiber with handle portion 502, hole 518 has a first portion 520 and a second portion 522. First portion 520 is configured to receive SC connector 550 and the associated optical fiber, while second portion 522 may be configured to only receive the optical fiber. In this manner, an individual can insert SC connector 550 and the associated optical fiber through first portion 520 and then slide the optical fiber into second portion 522. The frictional contact between second portion 522 and the optical fiber may prevent removal of the optical fiber from second portion 522. Additionally, SC connector 550 may prevent removal of the optical fiber from second portion 522. In other configurations, first and second portions 520 and 522 may be the same configuration. In still other configuration, first portion 520 may have a small diameter than second portion 522. In still other configurations, mechanical fastener or other structures may be used to aid with preventing the optical fiber and SC connector 550 from inadvertently being removed from hole 518.

The proximal end 514 of handle portion 502 engages with cap portion 504 by way of a hole or recess formed in cap portion 504. Alternatively, handle portion 502 can have a hole or recess that receives part of cap portion 504. Proximal end 514 can friction fit with cap portion 504 so that cap portion 504 is securely retained by handle portion 502 to avoid losing cap portion 504. In other configurations, mechanical fasteners or other structures that facilitate releasable attachment of cap portion 504 to handle portion 502 may be used. In still other configurations, cap portion 504 and handle portion 502 can be formed as a unitary piece during the manufacturing process.

Since handle portion 502 engages with the optical fiber associated with SC connector 550, handle portion 502 can aid with associating one particular cap portion 504 with a specific SC connector 550. This prevents an individual from wrongly attaching cap portion 504 to an SC connector different from the one to which handle portion 502 attaches.

In exemplary embodiments, endcap 500 can be made from various types of materials. These materials can be selected to have properties desirable in a connector cap. For example, these materials can be antistatic. They can be tested and certified to pass various flammability standards, such as, but not limited to, the Underwriters Laboratory (UL) UL94, V0 test. They can be certified to pass one or more of the outgassing standards of the American Society for Testing and Materials (ASTM), such as ASTM E595. The endcaps 500 can also be tested for reliability with respect to vibration, shock, temperature cycling, etc. Such materials can be, by way of example and not limitation, polypropylene, or other plastics or polymers known to those of skill in the art that have the desired properties.

While endcap 500 is designed to be used with a SC connector, exemplary embodiments of the present invention are not limited to caps for SC connectors. It is anticipated that all types of connectors currently in use can benefit from exemplary embodiments of the invention. Such other connectors can include, by way of example and not limitation, ST, STII, FC, AFC, FDDI, ESCON, and SMA.

The present invention may be embodied in other specific forms without departing from its spirit or essential characteristics. The described embodiments are to be considered in all respects only as illustrative and not restrictive. All changes which come within the meaning and range of equivalency of the disclosed embodiments are to be embraced within the scope of the invention.

1. A protective plug for an optoelectronic module, the plug comprising:
a base having two spaced apart insertion members extending from said base, wherein each of said insertion members comprises a recess insertable within a port of the module and a coplanar first surface with at least one stepped portion extending from said coplanar first surface.

2. The protective plug of claim 1, wherein each of said stepped portions is coplanar.

3. The protective plug of claim 1, wherein the module is one of a SFX module, a SFP module, a XFP module, and a GBIC module.

4. The protective plug of claim 1, wherein said plug comprises plastic.

5. The protective plug of claim 4, wherein said plastic comprises one of polyurethane, ethylene-propylene and diolefin monomer (EPDM).

6. The protective plug of claim 1, wherein each of said stepped portions fit within a corresponding structure in said module.

7. The protective plug of claim 1, further comprising a handle portion.

8. A protective plug for an optoelectronic module, the plug comprising:
a base having two spaced apart insertion members extending from said base, wherein each of said insertion members fits within a port of the module; and each of said insertion members having at least one stepped portion that is coplanar with an outside surface of said base.

9. The protective plug of claim 7, wherein each of said stepped portions is coplanar with each other.

10. The protective plug of claim 8, wherein the module is one of a SFX module, a SFP module, a XFP module, and a GBIC module.

11. The protective plug of claim 8, wherein said plug comprises plastic.

12. The protective plug of claim 11, wherein said plastic comprises one of polyurethane and ethylene-propylene diolefin monomer (EPDM).

13. The protective plug of claim 8, wherein each of said stepped portions fits within a corresponding structure in said module.

14. The protective plug of claim 8, further comprising a handle portion.

15. A protective end cap for and optical connector, the end cap comprising:
first and second spaced apart side walls;
at least one recess in one of a third and fourth side wall, said at least one recess located such that said recess engages with a corresponding tab on the optical connector when the end cap is placed on the optical connector;
an annular member located in an interior portion of the end cap, said annular member designed to receive a portion of a fiber optic cable that extends from an end of the optical connector.

16. The protective end cap of claim 15, wherein an end face of said portion of said fiber optic connector does not contact the end cap.

17. The protective end cap of claim 15, further comprising a pair of recesses, each of the pair of recesses located in one of the third and fourth side walls, wherein each of said recesses engages with a corresponding tab on the optical connector when the end cap is placed on the optical connector.

18. The protective end cap of claim 15, wherein said end cap comprises polypropylene.

19. The protective end cap of claim 15, wherein the optical connector is one of an SC, ST, STIJ, FC, AFC, FDDI, ESCON, and SMA connector.
